(19) United States
(12) Patent Application Publication
(10) Pub. No.: US 2014/0255039 A1
(43) Pub. Date: Sep. 11, 2014

(54) ESTABLISHING OPTICAL COHERENCE USING FREE-SPACE OPTICAL LINKS

(71) Applicant: PHASE SENSITIVE INNOVATIONS, INC, Newark, DE (US)

(72) Inventors: Dennis W. Prather, Newark, DE (US); Garrett Schneider, New Castle, DE (US); Janusz Murakowski, Newark, DE (US)

(73) Assignee: PHASE SENSITIVE INNOVATIONS, INC, Newark, DE (US)

(21) Appl. No.: 13/785,465

(22) Filed: Mar. 5, 2013

(51) Int. Cl. H04B 10/112

(52) U.S. Cl. CPC H04B 10/112
USPC 398/130

(57) ABSTRACT

An apparatus and/or method may be used for distributed synchronization of oscillators at non-collocated stations by means of transmitting and receiving optical signals having frequencies related to a desired oscillator frequency.

### FIELD

Various embodiments of the invention may relate to establishing coherence among radio-frequency (RF) sources of multiple communication apparatuses using free-space optical links.

### BACKGROUND

Spatially isolated radio receivers can be combined to form a much larger effective single aperture with vastly improved angular resolution, as is common practice in radio astronomy. This functionality may only be possible, however, if the separate receivers can be made coherent, i.e., synchronized to a common reference signal or clock, called a “master oscillator” (MO). That is the local oscillators (LOs) of the various receivers should be synchronized to the MO. The invariance of electromagnetism under time reversal guarantees that comparable functionality can be realized with source arrays as well as receivers. Synchronization of the LOs of the elements in an array is typically accomplished by directly connecting the receivers via either electrical cables or optical fibers. However, this means that the receivers (or sources) must be physically linked, and this may be difficult in some situations.

### SUMMARY OF EMBODIMENTS OF THE INVENTION

In various embodiments of the invention, coherence may be established among various receivers and/or sources by distributing a MO wirelessly via free-space line-of-sight optical links. Various embodiments of the invention may involve methods, apparatus, and/or systems involving such wireless distribution of an MO.

### BRIEF DESCRIPTION OF THE DRAWINGS

Various embodiments of the invention are described below in conjunction with the accompanying drawings, in which:

FIG. 1 is system in which various embodiments of the invention may be implemented;

FIG. 2 shows a flowchart of a method according to an embodiment of the invention; and

FIG. 3 shows a flowchart of a method according to an embodiment of the invention.

### DETAILED DESCRIPTION OF VARIOUS EMBODIMENTS

Various embodiments of the invention may relate to the processing of RF signals or other electromagnetic signals. The subsequent discussion will discuss RF signals, but the invention is not necessarily limited to such signals.

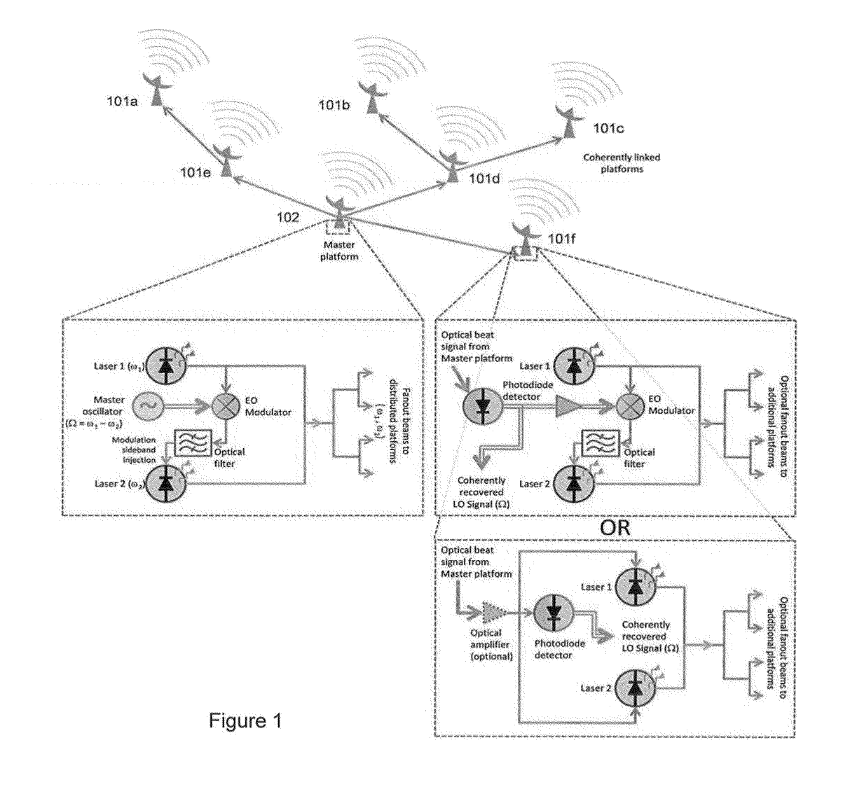

To briefly outline the more-detailed discussion below, optical MO distribution may be achieved by simultaneously transmitting two optical sources of closely-spaced frequencies, such that their frequency difference is comparable to radio frequencies of interest. When the two optical frequencies are incident simultaneously on a photodetector, the resulting signal, or “beat tone,” may correspond to an RF signal that, in principle, may be used as an LO. FIG. 1 provides an exemplary embodiment of such a system.

FIG. 1 shows a set of distributed communication devices (receivers and/or transmitters) 101a-101f and 102. In an embodiment of the invention, 101a-101f may be devices whose LOs may be synchronized to an MO of a master device 102 at a frequency Ω. At master device 102, an MO may generate a signal at a frequency to which it is desired that the LOs at devices 101a-101f may be synchronized. A first optical source (shown as “Laser 1” in FIG. 1) may generate an optical signal of frequency ω₁. This optical signal may be fed to an electro-optical (EO) modulator, to which the output signal of the MO may also be fed. The resulting optical signal output of the EO modulator may be filtered using an optical filter. The result may be used to drive a second optical source (shown as “Laser 2” in FIG. 1) at a second frequency ω₂; this may involve modulation sideband injection. In such a way, the output optical signals from Laser 1 and Laser 2 may be heterodyne-injection locked via the EO modulation (a technique for performing such operations is discussed, e.g., in Schneider et al., Optical Generation of Narrow-line RF by Injection Locking of Modulated DFB Lasers, CLEO, November 2011, incorporated by reference herein; see, also, PCT International Patent Application Publication No. WO 2012/099914, also incorporated by reference herein). The frequencies of the MO and the output optical signals of Laser 1 and Laser 2 may, as a result, be related according to Ω=ω₁−ω₂. The resulting output optical signals of Laser 1 and Laser 2 may then be transmitted to the various other devices 101a-101f.

In this embodiment, the output optical signals from Laser 1 and Laser 2 of master device 102 may be received at one of the other devices, e.g., device 101f. Device 101f may include a photodetector, e.g., a photodiode-based detector, upon which the two optical signals from master device 102 may be incident. The photodetector may, in response to the incident optical signals, generate a “beat tone” of frequency Ω=ω₁−ω₂. This may be used to synchronize a LO of device 101f (or to act as a synchronized LO of the device, if the MO continues to transmit the optical signals). Similar operations may be performed at devices 101a-101e.

In embodiments of the invention, the optical outputs signals of Laser 1 and Laser 2 of master device 102 may be transmitted to the other devices 101a-101f via free-space optical beams, where each beam may be a combination of the output signals. Because radio frequencies represent a tiny fraction of optical frequencies (˜0.05%), there may be negligible net disturbance of the signal by atmospheric effects and dispersion, i.e., both optical beams may typically be identically disturbed as they travel, so all effects of such disturbances may cancel out upon photodetection of the beat tone.

In some embodiments, the master device 102 may not transmit optical signals directly to every other device 101a-101f. This may be due to the fact that, in some environments, it may not be possible to establish line-of-sight (LOS) links from master device 102 to all of the other devices 101a-101f, e.g., due to obstructions. Therefore, it may be useful to provide one or more of devices 101a-101f with the ability to “pass along” optical signals to be used for locking LOs of further devices.

In such an embodiment, a device, such as device 101f, may be able to amplify the output of the photodetector and may feed the amplified signal (i.e., the amplified beat tone) to an EO modulator. The EO modulator may receive an input optical signal from a first optical source (“Laser 1” of device 101f), and the EO modulator may modulate the optical output of Laser 1 of device 101f with the amplified detected beat tone. The result may be filtered in an optical filter, and the filtered result may be fed to a second optical source (“Laser 2” of device 101f). That is, a device, such as device 101f, may be configured similarly to master device 102 with respect to transmitting an oscillator signal using two optical signals. As was the case with the output optical signals of Laser 1 and Laser 2 of master device 102, the output optical signals of Laser 1 and Laser 2 may be transmitted to one or more further devices (e.g., if 101e is thus outfitted, it may transmit to 101a) by transmitting them in one or more free-space optical beams.

The locking of a remote platform's LO, by passing along optical synchronization signals from a first platform receiving optical synchronization signals (where the original optical synchronization signals (ultimately) originated at a master device 102), can be achieved in at least two ways. In a first embodiment, the optical source beams may be captured at the device (e.g., device 101a-101f) with a photodetector (e.g., a photodiode detector), which may then be followed by amplifying and using the resulting beat tone to drive a EO modulator. The photodetector and the EO modulator may need to be fast, to provide adequate performance. The modulation sideband may then be used to injection lock another pair of optical sources to a frequency offset equal to and coherent with the master oscillator. These lasers' outputs can then be passed along to another platform, and so on. This is the case discussed in one of the above embodiments. In this case, each platform may be equipped with such photodetector and EO modulator to recover the optical beat tone as an electrical signal.

In a further embodiment, the optical source beams may be captured and may, if necessary, be directly amplified, e.g., by one or more optical amplifiers, in the optical domain. These optical references may then be used to injection seed another pair of optical sources that have been tuned to closely match the received signals' wavelengths, which may, in turn, allow this further pair of optical sources to be injection locked to the respective wavelength-matched lasers on the master platform. By keeping the reference signal in the optical domain, the system may not require a high-speed modulator on each platform (however, the MO platform may typically still require one).

To realize the full advantages of distributed coherent platforms, the platforms must be coherent, and such coherence may be provided by embodiments of the present invention. However, accurate knowledge of the relative positions of platforms to within a fraction of the RF wavelength may also be needed, so that the precise signal time delay associated with each platform necessary can be applied, for phased-array beam-forming. This knowledge can be obtained by independent means such as precise GPS systems, or it can be monitored by tracking the phase drift of the beat tones received on each platform, since any relative motion between the platforms would cause a measurable phase change that can be used to accurately and continuously monitor this motion.

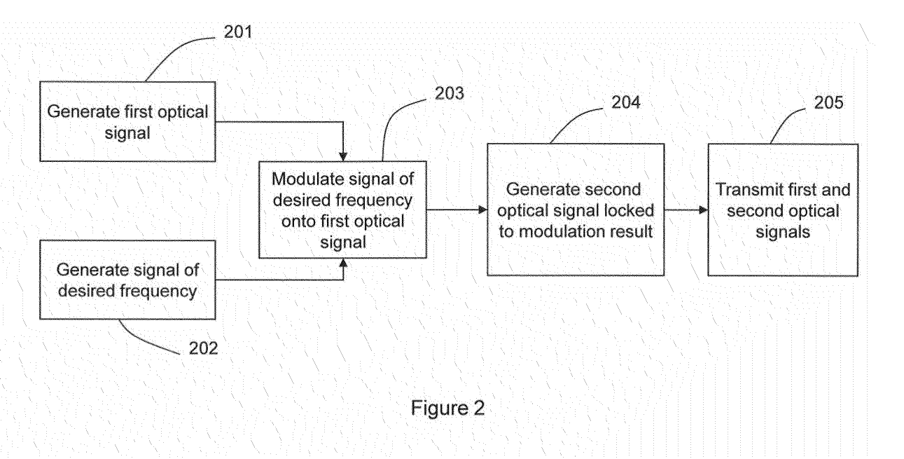

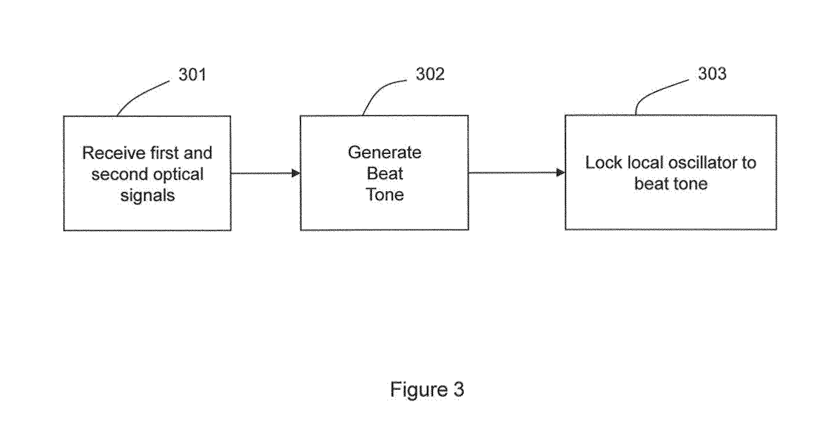

FIGS. 2 and 3 contain flowcharts showing how various aspects of embodiments of the invention may operate. In FIG. 2, a first optical signal may be generated 201 and a signal of a desired frequency (e.g., the MO signal) may be generated 202. The signal of desired frequency may then be modulated onto the first optical signal 203. The result may be used to generate a second optical signal 204. The first and second optical signals may then be transmitted 205, in order to provide synchronization signals to other devices.

In FIG. 3, first and second optical signals may be received 301. The first and second optical signals may have frequencies whose difference may correspond to a desired oscillator frequency. A beat tone may be generated 302 based on the first and second optical signals. An LO may then be locked to the beat tone 303.

Note that, in some embodiments, the LO locked to the beat tone 303 in FIG. 3 may serve as the means by which to generate a signal of desired frequency 202, as in FIG. 2. Thus, these methods may be linked together to provide an serial method of synchronizing LOs to an MO.

It is further noted that, although the techniques described herein have been described with a focus on synchronization of local oscillators being used to generate signals used in RF transmitting and/or receiving systems, the invention is not thus limited. It is contemplated that the techniques discussed above may have far broader applications, such as remote synchronization of signals of arbitrary frequencies, for a variety of purposes.

Various embodiments of the invention have now been discussed in detail; however, the invention should not be understood as being limited to these embodiments. It should also be appreciated that various modifications, adaptations, and alternative embodiments thereof may be made within the scope and spirit of the present invention.

What is claimed is:

1. A method, comprising:
generating, at a first station, a first optical signal at a first frequency;
generating an oscillation signal at a desired frequency;
modulating the first optical signal with the oscillation signal to obtain a modulated signal;
generating a second optical signal frequency-locked to the modulated signal; and
transmitting the first and second optical signals from the first station to one or more stations not collocated with the first station to enable the one or more non-collocated stations to synchronize respective one or more local oscillators.

2. The method of claim 1, further comprising:
combining the first and second optical signals into an optical beam prior to said transmitting, and wherein said transmitting comprises transmitting the optical beam.

3. The method of claim 1, wherein the first station is a master station, and wherein generating the oscillation signal comprises generating the oscillation signal from a master oscillator located at the master station.

4. The method of claim 1, wherein generating the oscillation signal comprises generating the oscillation signal based on at least one received signal at the first station.

5. The method of claim 4, wherein generating the oscillation signal comprises:
receiving an optical beam containing optical signals having respective frequencies related to the desired frequency; and
generating a beat tone at the desired frequency based on the received optical beam.

6. The method of claim 5, wherein the desired frequency is equal to a difference between the frequencies of the optical signals.

7. A method, comprising:
generating, at a station, a beat tone at a desired frequency based on received optical signals having respective frequencies related to a desired frequency to which to synchronize a local oscillation signal of the station; and
using the beat tone to provide the synchronized local oscillation signal of the station.

8. The method of claim 7, wherein using the beat tone to provide the synchronized local oscillation signal comprises locking a local oscillator of the station to a frequency of the beat tone.

9. The method of claim 7, wherein generating the beat tone comprises simultaneously receiving the optical signals at a common photodetector.

10. The method of claim 7, further comprising:
capturing the respective received optical signals;
generating respective further optical signals locked to the respective received optical signals; and
transmitting the further optical signals to at least one other station to enable the at least one other station to synchronize a local oscillation signal of the at least one other station to the desired frequency.

11. The method of claim 7, wherein the desired frequency is equal to a difference between the frequencies of the optical signals.

12. An apparatus, comprising:
a first optical source configured to generate a first optical signal having a first frequency;
an oscillator configured to generate an oscillation signal at a desired frequency;
an electro-optical modulator coupled to the first optical source and to the oscillator and configured to modulate the first optical signal with the oscillation signal; and
a second optical source coupled to an output of the electro-optical modulator and configured to generate a second optical signal locked to an output signal of the electro-optical modulator,
wherein the apparatus is configured to transmit the first and second optical signals to a non-collocated apparatus.

13. The apparatus of claim 12, further comprising:
an optical filter coupled between the electro-optical modulator and an input to the second optical source and configured to filter the output signal of the electro-optical source.

14. The apparatus of claim 12, wherein the second optical source is configured to generate the second optical signal locked to the output signal of the electro-optical modulator by means of modulation sideband injection.

15. An apparatus, comprising:
a photodetector configured to receive optical signals of respective frequencies related to a desired frequency and to generate a beat tone having a frequency equal to a difference between the respective frequencies; and
wherein the apparatus is configured to be locked to a frequency of the beat tone.

16. The apparatus of claim 15, further comprising:
a first optical source configured to generate a first optical signal having a first frequency;
an electro-optical modulator coupled to the first optical source and coupled to receive the beat tone, the electro-optical modulator configured to modulate the first optical signal with the beat tone; and
a second optical source coupled to an output of the electro-optical modulator and configured to generate a second optical signal locked to an output signal of the electro-optical modulator,
wherein the apparatus is configured to transmit the first and second optical signals to a non-collocated apparatus.

17. The apparatus of claim 16, further comprising an amplifier configured to amplify the beat tone.

18. The apparatus of claim 15, further comprising:
a first optical source coupled to a first one of the received optical signals and configured to generate a first optical signal having a frequency locked to the frequency of the first one of the received optical signals;
a second optical source coupled to a second one of the received optical signals and configured to generate a second optical signal locked to the frequency of the second one of the received optical signals,
wherein the apparatus is configured to transmit the first and second optical signals to a non-collocated apparatus.

19. The apparatus of claim 15, further comprising:
a local oscillator configured to be locked to the frequency of the beat tone and to generate a local oscillator signal having a frequency locked to the frequency of the beat tone.
